(19) United States
(12) Patent Application Publication
(10) Pub. No.: US 2026/0132679 A1
(43) Pub. Date: May 14, 2026

(54) Modular Ladder Assembly

(71) Applicant: Banu Basdeo, Etobicoke (CA)

(72) Inventor: Banu Basdeo, Etobicoke (CA)

(21) Appl. No.: 18/946,176

(22) Filed: Nov. 13, 2024

(51) Int. Cl. E06C 1/36; E06C 1/38; E06C 7/02; E06C 7/08

(52) U.S. Cl. CPC E06C 1/36; E06C 1/381; E06C 7/02; E06C 7/086

(57) ABSTRACT

A modular ladder assembly includes a lower sleeve with a plurality of first engagement points and a plurality of second engagement points. An upper sleeve is slidably insertable into the lower sleeve to extend along a full height of a framed wall. The upper sleeve has a plurality of primary engagement points and a plurality of secondary engagement points. A plurality of first pegs is attachable to a respective one of the first engagement points or a respective one of the primary engagement points to facilitate a user to climb on the plurality of first pegs. A plurality of second pegs is insertable into a respective one of the second engagement points to engage the framed wall. A plurality of third pegs is insertable into a respective one of the second engagement points to engage the framed wall.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention.

The disclosure relates to ladder devices and more particularly pertains to a new ladder device for facilitating a user to climb a framed wall without a ladder. The device includes a lower sleeve and an upper sleeve that is insertable into the lower sleeve such that the lower sleeve and the upper sleeve can extend along a full height of a framed wall. The device includes a plurality of first pegs that is each insertable into the first sleeve and the second sleeve to facilitate a user to climb the first pegs. The device includes a plurality of second pegs and a plurality of third pegs that are each insertable into the upper sleeve and the lower sleeve to engage the framed wall thereby inhibiting the lower sleeve and the upper sleeve from sliding laterally on the framed wall.

### (2) Description of Related Art including information disclosed under 37 CFR 1.97 and 1.98.

The prior art relates to ladder devices including a rail system which includes a pair of vertical members that are attachable to a wall and a scaffolding unit that is attachable to the vertical members. The prior art discloses a wall scaffolding device that includes a pair of supports that are attachable to roof rafters, a pair of hangers attached to the supports and a scaffold attached to the hangers. The prior art discloses a support cage that includes a pair of hangers that each engages a top of a wall to support the support cage on the wall. The prior art discloses a variety of scaffold devices that each at least includes a pair of hangers that engage a top of a wall and a scaffold attached to the hangers.

### (H) BRIEF SUMMARY OF THE INVENTION

An embodiment of the disclosure meets the needs presented above by generally comprising a lower sleeve with a plurality of first engagement points and a plurality of second engagement points. An upper sleeve is slidably insertable into the lower sleeve to extend along a full height of a framed wall. The upper sleeve has a plurality of primary engagement points and a plurality of secondary engagement points. A plurality of first pegs is attachable to a respective one of the first engagement points or a respective one of the primary engagement points to facilitate a user to climb on the plurality of first pegs. A plurality of second pegs is insertable into a respective one of the second engagement points to engage the framed wall. A plurality of third pegs is insertable into a respective one of the second engagement points to engage the framed wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a modular ladder assembly according to an embodiment of the disclosure.

FIG. 2 is a front perspective view of an embodiment of the disclosure.

FIG. 3 is a right side view of an embodiment of the disclosure.

FIG. 4 is a perspective in-use view of an embodiment of the disclosure.

FIG. 5 is a cross sectional view taken along line 5-5 of FIG. 3 of an embodiment of the disclosure.

FIG. 6 is an exploded perspective view of an embodiment of the disclosure.

FIG. 7 is an exploded left side view of an embodiment of the disclosure.

FIG. 8 is an exploded right side view of an embodiment of the disclosure.

### (J) DETAILED DESCRIPTION OF THE INVENTION

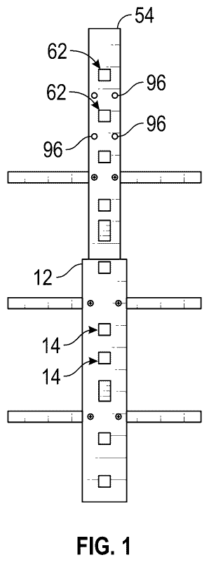

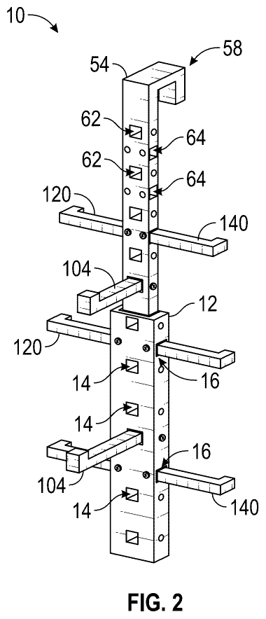

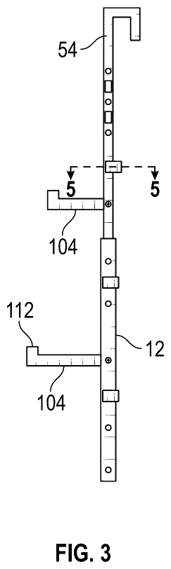

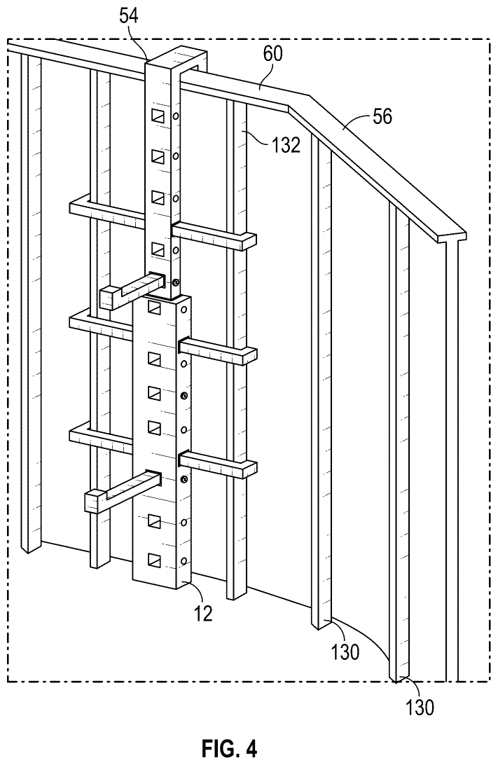

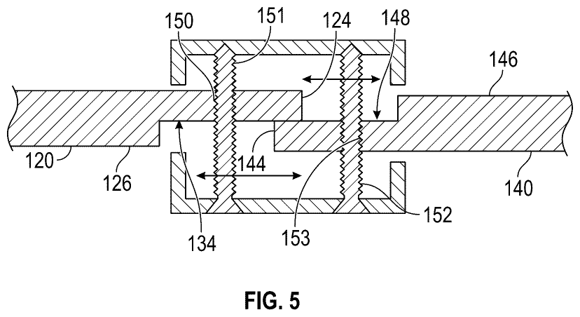

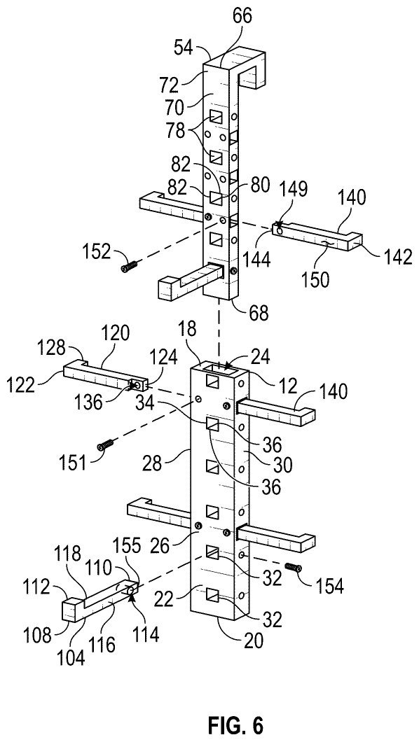

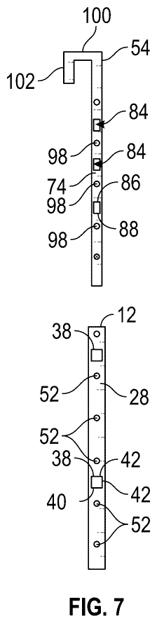

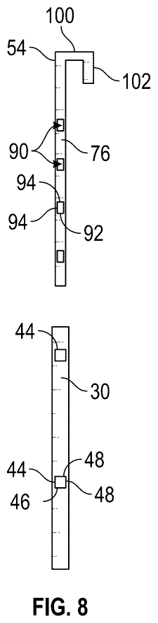

With reference now to the drawings, and in particular to FIGS. 1 through 8 thereof, a new ladder device embodying the principles and concepts of an embodiment of the disclosure and generally designated by the reference numeral 10 will be described.

As best illustrated in FIGS. 1 through 8, the modular ladder assembly 10 generally comprises a lower sleeve 12 that has a plurality of first engagement points 14 distributed along a full length of the lower sleeve 12 and a plurality of second engagement points 16 distributed along a full length of the lower sleeve 12. The lower sleeve 12 has a top end 18, a bottom end 20 and an outer wall 22 extending between the top end 18 and the bottom end 20 and the lower sleeve 12 is substantially hollow. The top end 18 has an opening 24 extending into an interior of the lower sleeve 12 and the outer wall 22 has a front side 26, a first lateral side 28 and a second lateral side 30. The front side 26 has a plurality of first holes 32 each extending into the interior of the lower sleeve 12 such that the plurality of first holes 32 defines the plurality of first engagement points 14.

Each of the plurality of first holes 32 has a bounding edge 34 which has a plurality of intersecting sides 36 such that each of the plurality of first holes 32 has a rectangular shape. The plurality of first holes 32 is spaced apart from each other and evenly distributed between the top end 18 and the bottom end 20. The first lateral side 28 has a pair of second holes 38 each extending into the interior of the lower sleeve 12 and each of the plurality of second holes 38 has bounding edge 40 which has a plurality of intersecting sides 42 such that each of the plurality of second holes 38 has a rectangular shape. The second lateral side 30 has a pair of third holes 44 each extending into the interior of the lower sleeve 12 and each of the plurality of third holes 44 has bounding edge 46 which has a plurality of intersecting sides 48 such that each of the plurality of third holes 44 has a rectangular shape. Each of the third holes 44 is aligned with a respective one of the second holes 38 such that each of the third holes 44 and the respective second hole 38 defines a respective one of the second engagement points 16.

The front side 26 has a plurality of first fastener holes 50 each extending into the interior of the lower sleeve 12 and each of the plurality of first fastener holes 50 is aligned with a respective one of the second holes 38 or a respective one of the third holes 44. The first lateral side 28 has a plurality of second fastener holes 52 extending into the interior of the lower sleeve 12. Each of the plurality of second fastener holes 52 is aligned with a respective one of the first holes 32.

An upper sleeve 54 is slidably insertable into the lower sleeve 12 such that the upper sleeve 54 and the lower sleeve 12 has an adjustable combined length. In this way the upper sleeve 54 and the lower sleeve 12 can be positioned to extend along a full height of a framed wall 56. The framed wall 56 may be an unfinished interior wall of a building, such as a house for example, that is under construction. The upper sleeve 54 has a gripping element 58 to engage a top plate 60 of the framed wall 56 thereby attaching the upper sleeve 54 and the lower sleeve 12 to the framed wall 56. The upper sleeve 54 has a plurality of primary engagement points 62 distributed along a full length of the lower sleeve 12. Respective ones of the primary engagement points 62 is alingable with a respective one of the first engagement points 14 in the lower sleeve 12 when the combined length of the upper sleeve 54 and the lower sleeve 12 is adjusted. The upper sleeve 54 has a plurality of secondary engagement points 64 distributed along a full length of the upper sleeve 54.

The upper sleeve 54 has an upper end 66, a lower end 68 and an outside wall 70 extending between the upper end 66 and the lower end 68 and the outside wall 70 has a forward side 72, a primary lateral side 74 and a secondary lateral side 76. The upper sleeve 54 is substantially hollow and the forward side 72 has a plurality of primary holes 78 each extending into the interior of the upper sleeve 54 such that the plurality of primary holes 78 defines the plurality of primary engagement points 62. Each of the plurality of primary holes 78 has a bounding edge 80 which has a plurality of intersecting sides 82 such that each of the plurality of primary holes 78 has a rectangular shape. The plurality of primary holes 78 is spaced apart from each other and evenly distributed between the top end 18 and the bottom end 20.

The primary lateral side 74 has a pair of secondary holes 84 each extending into the interior of the lower sleeve 12. Each of the plurality of secondary holes 84 has a bounding edge 86 which has a plurality of intersecting sides 88 such that each of the plurality of secondary holes 84 has a rectangular shape. The secondary lateral side 76 has a pair of tertiary holes 90 each extending into the interior of the lower sleeve 12 and each of the plurality of tertiary holes 90 has a bounding edge 92 which has a plurality of intersecting sides 94 such that each of the plurality of tertiary holes 90 has a rectangular shape. Each of the tertiary holes 90 is aligned with a respective one of the secondary holes 84 such that each of the tertiary holes 90 and the respective secondary hole 84 defines a respective one of the secondary engagement points 64.

The forward side 72 has a plurality of primary fastener holes 96 each extending into the interior of the lower sleeve 12 and each of the plurality of primary fastener holes 96 is aligned with a respective one of the secondary holes 84 or a respective one of the tertiary holes 90. The primary lateral side 74 has a plurality of secondary fastener holes 98 extending into the interior of the lower sleeve 12 and each of the plurality of secondary fastener holes 98 is aligned with a respective one of the primary holes 78. Each of the primary fastener holes 96 is aligned with a respective one of the first fastener holes 50 associated with the lower sleeve 12 when the upper sleeve 54 is inserted into the lower sleeve 12. Each of the secondary fastener holes 98 is aligned with a respective one of the second fastener holes 52 associated with the lower sleeve 12 when the upper sleeve 54 is inserted into the lower sleeve 12. Additionally, the upper sleeve 54 has a leg 100 extending away from the upper end 66 and a foot 102 extending downwardly from the leg 100 having the foot 102 being spaced from the outside wall 70 of the upper sleeve 54. The leg 100 and the foot 102 are extendable over and behind a top plate 60 of the framed wall 56 for retaining the upper sleeve 54 and the lower sleeve 12 on the framed wall 56.

A plurality of first pegs 104 is provided and each of the first pegs 104 is attachable to a respective one of the first engagement points 14 in the lower sleeve 12 or a respective one of the primary engagement points 62 in the upper sleeve 54. In this way each of the plurality of first pegs 104 facilitates a user 106 to climb on the plurality of first pegs 104 thereby scaling the framed wall 56 without requiring the user 106 to employ a conventional ladder thereby eliminating the possibility of injury as a result of the conventional ladder tipping over. Each of the plurality of first pegs 104 has a first end 108 and a second end 110 and each of the plurality of first pegs 104 has a foot 112 extending away from the first end 108. Each of the plurality of first pegs 104 has an aperture 114 extending through a first lateral side 116 and a second lateral side 118 of the first pegs 104. The aperture 114 in each of the plurality of first pegs 104 is positioned adjacent to the second end 110.

The second end 110 of a respective one of the plurality of first pegs 104 is insertable into a respective one of the first holes 32 in the front side 26 of the outer wall 22 of the lower sleeve 12 and the primary hole 78 in the forward side 72 of the outside wall 70 of the upper sleeve 54 that is aligned with the respective first hole 32. Additionally, the aperture in the respective first peg 104 is aligned with a respective pair of the first fastener holes 50 and the second fastener holes 52 associated with the lower sleeve 12 and a respective pair of the primary fastener holes 96 and the secondary fastener holes 98 associated with the upper sleeve 54.

A plurality of second pegs 120 is each insertable into a respective one of the second engagement points 16 in the lower sleeve 12 and a respective one of the secondary engagement points 64 in the upper sleeve 54 to engage the framed wall 56. Each of the second pegs 120 has a primary end 122, a secondary end 124 and a first surface 126 extending between the primary end 122 and the secondary end 124. Each of the plurality of second pegs 120 has a foot 128 extending away from the primary end 122 to engage a lateral side 130 of a respective one of a plurality of studs 132 in the framed wall 56. Each of the plurality of second pegs 120 has a recess 134 in the first surface 126 extending from the secondary end 124 toward the primary end 122 and each of the plurality of second pegs 120 has an aperture 136 extending through the first surface 126 and a second surface 138 of the second pegs 120. Additionally, the aperture 136 associated with each of the plurality of second pegs 120 is positioned in the recess 134. The secondary end 124 of a respective one of the second pegs 120 is insertable into a respective one of the second holes 38 in the first lateral side 28 of the outer wall 22 of the lower sleeve 12 and a respective one of the secondary holes 84 in the primary lateral side 74 of the outside wall 70 of the upper sleeve 54. Additionally, the aperture 136 associated with the respective second peg 120 is aligned with a respective one of the first fastener holes 50 in the front side 26 of the outer wall 22 of the lower sleeve 12.

A plurality of third pegs 140 is each insertable into a respective one of the second engagement points 16 in the lower sleeve 12 and a respective one of the secondary engagement points 64 in the upper sleeve 54 thereby facilitating each of the plurality of third pegs 140 to engage the framed wall 56. Each of the third pegs 140 has a primary end 142, a secondary end 144 and a first surface 146 extending between the primary end 142 and the secondary end 144 of the third pegs 140. Each of the plurality of third pegs 140 has a foot 147 extending away from the primary end 142 of the third pegs 140 to engage a lateral side 130 of a respective one of the plurality of studs 132 in the framed wall 56. Each of the plurality of third pegs 140 has a recess 148 in the first surface 146 of the third pegs 140 which extends from the secondary end 144 toward the primary end 142 of the third pegs 140. Each of the plurality of third pegs 140 has an aperture 149 extending through the first surface 146 of the third pegs 140 and a second surface 150 of the third pegs 140 and the aperture 149 associated with each of the plurality of third pegs 140 is positioned in the recess 148 associated with the third pegs 140.

The secondary end 144 of a respective one of the third pegs 140 is insertable into a respective one of the third holes 44 in the second lateral side 30 of the outer wall 22 of the lower sleeve 12 and a respective one of the tertiary holes 90 in the secondary lateral side 76 of the outside wall 70 of the upper sleeve 54. Furthermore, the aperture 149 associated with the respective third peg 140 is aligned with a respective one of the first fastener holes 50 in the front side 26 of the outer wall 22 of the lower sleeve 12. The secondary end 144 of the respective third peg 140 overlaps the secondary end 124 of the respective second peg 120 when the respective third peg 140 and the respective second peg 120 are each inserted into the respective second engagement points 16.

A plurality of first fasteners 151 is each insertable through a respective one of first fastener holes 50 in the front side 26 of the outer wall 22 of the lower sleeve 12 or a respective one of the primary fastener holes 96 in the forward side 72 of the outside wall 70 of the upper sleeve 54. Each of the plurality of first fasteners 151 extends through the aperture 136 in a respective one of the second pegs 120 to secure the respective second peg 120 in the lower sleeve 12 or the upper sleeve 54. Each of the first fasteners 151 may comprise a screw or other threaded fastener which threadably engages a bounding edge 150 of the aperture 136 in the respective second peg 120.

A plurality of second fasteners 152 is provided and each of the plurality of second fasteners 152 is insertable through a respective one of the first fastener holes 50 in the front side 26 of the outer wall 22 of the lower sleeve 12 or a respective one of the primary fastener holes 96 in the forward side 72 of the outside wall 70 of the upper sleeve 54. Each of the second fasteners 152 extends through the aperture 149 in a respective one of the third pegs 140 for securing the respective third peg 140 in the lower sleeve 12 or the upper sleeve 54. Additionally, each of the second fasteners 152 may comprise a screw or other type of threaded fastener which threadably engages a bounding edge 153 of the aperture 149 in the respective third peg 140.

A plurality of third fasteners 154 is provided and each of the plurality of third fasteners 154 is insertable through a respective one of the second fastener holes 52 in the first lateral side 28 of the outer wall 22 of the lower sleeve 12 or a respective one of the secondary fastener holes 98 in the primary lateral side 74 of the outside wall 70 of the upper sleeve 54. Each of the third fasteners 154 extends through the aperture 114 in a respective one of the first pegs 104 for securing the respective first peg 104 in the lower sleeve 12 or the upper sleeve 54. Additionally, each of the first fasteners 151 may comprise a screw or other threaded fastener that threadably engages a bounding edge 155 of the aperture 114 in the respective first peg 104.

In use, the lower sleeve 12 is vertically oriented on a floor 156 upon which the framed wall 56 is positioned and the lower end 68 of the upper sleeve 54 is inserted into the top end 18 of the lower sleeve 12 such that the leg 100 and the foot 102 associated with the upper sleeve 54 extends over and behind the top plate 60 of the framed wall 56. The plurality of first pegs 104 is inserted into respective first holes 32 in the lower sleeve 12 and the primary hole 78 in the upper sleeve 54 that is aligned with the respective first hole 32. Furthermore, respective third pegs 140 are inserted into respective primary holes 78 in the upper sleeve 54 that are exposed with respect to the lower sleeve 12. The plurality second pegs 120 is inserted into the respective second hole 38 in the lower sleeve 12 and the secondary hole 84 in the upper sleeve 54 that is aligned with the respective second hole 38. Additionally, respective second pegs 120 are inserted into respective secondary holes 84 in the upper sleeve 54 that are exposed with respect to the lower sleeve 12. The plurality third pegs 140 is inserted into the respective third holes 44 in the lower sleeve 12 and the tertiary hole 90 in the upper sleeve 54 that is aligned with the respective third hole 44. Additionally, respective third pegs 140 are inserted into respective tertiary holes 90 in the upper sleeve 54 that are exposed with respect to the lower sleeve 12. In this way the user 106 can climb the plurality of plurality of first pegs 104 while the plurality of second pegs 120 and the plurality of third pegs 140 inhibit the lower sleeve 12 and the upper sleeve 54 from sliding laterally on the framed wall 56. Thus, the user 106 can safely apply gypsum board, for example, on the framed wall 56 or perform other work on the framed wall 56 without being exposed to the risk of injury that can result from a ladder tipping.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular ladder assembly for facilitating a worker to climb along a framed wall, said assembly comprising:
a lower sleeve having a plurality of first engagement points being distributed along a full length of said lower sleeve, said lower sleeve having a plurality of second engagement points being distributed along a full length of said lower sleeve;
an upper sleeve being slidably insertable into said lower sleeve such that said upper sleeve and said lower sleeve has an adjustable combined length wherein said upper sleeve and said lower sleeve is configured to extend along a full height of a framed wall, said upper sleeve having a gripping element wherein said gripping element is configured to engage a top of the framed wall thereby attaching said upper sleeve and said lower sleeve to the framed wall, said upper sleeve having a plurality of primary engagement points being distributed along a full length of said lower sleeve, respective ones of said primary engagement points being alingable with a respective one of said first engagement points in said lower sleeve when said combined length of said upper sleeve and said lower sleeve is adjusted, said lower sleeve having a plurality of secondary engagement points being distributed along a full length of said lower sleeve;
a plurality of first pegs, each of said first pegs being attachable to a respective one of said first engagement points in said lower sleeve or a respective one of said primary engagement points in said upper sleeve wherein each of said plurality of first pegs is configured to facilitate a user to climb on said plurality of first pegs thereby scaling the framed wall;
a plurality of second pegs, each of said second pegs being insertable into a respective one of said second engagement points in said lower sleeve and a respective one of said secondary engagement points in said upper sleeve wherein each of said plurality of second pegs is configured to engage the framed wall; and
a plurality of third pegs, each of said third pegs being insertable into a respective one of said second engagement points in said lower sleeve and a respective one of said secondary engagement points in said upper sleeve wherein each of said plurality of third pegs is configured to engage the framed wall.

2. The assembly according to claim 1, wherein:
said lower sleeve has a top end, a bottom end and an outer wall extending between said top end and said bottom end, lower sleeve being substantially hollow, said top end having an opening extending into an interior of said lower sleeve, said outer wall having a front side, a first lateral side and a second lateral side;
said front side has a plurality of first holes each extending into said interior of said lower sleeve such that said plurality of first holes defines said plurality of first engagement points, each of said plurality of first holes having a bounding edge which has a plurality of intersecting sides such that each of said plurality of first holes has a rectangular shape, said plurality of first holes being spaced apart from each other and being evenly distributed between said top end and said bottom end;
said first lateral side has a pair of second holes each extending into said interior of said lower sleeve, each of said plurality of second holes having bounding edge which has a plurality of intersecting sides such that each of said plurality of second holes has a rectangular shape; and
said second lateral side has a pair of third holes each extending into said interior of said lower sleeve, each of said plurality of third holes having bounding edge which has a plurality of intersecting sides such that each of said plurality of third holes has a rectangular shape, each of said third holes being aligned with a respective one of said second holes such that each of said third holes and said respective second hole defines a respective one of said second engagement points.

3. The assembly according to claim 2, wherein said front side has a plurality of first fastener holes each extending into said interior of said lower sleeve, each of said plurality of first fastener holes being aligned with a respective one of said second holes or a respective one of said third holes.

4. The assembly according to claim 3, wherein said first lateral side has a plurality of second fastener holes extending into said interior of said lower sleeve, each of said plurality of second fastener holes being aligned with a respective one of said first holes.

5. The assembly according to claim 1, wherein:
said upper sleeve has a upper end, a lower end and an outside wall extending between said upper end and said lower end, said upper sleeve being substantially hollow, said outside wall having a forward side, a primary lateral side and a secondary lateral side;
said forward side has a plurality of primary holes each extending into said interior of said upper sleeve such that said plurality of primary holes defines said plurality of primary engagement points, each of said plurality of primary holes having a bounding edge which has a plurality of intersecting sides such that each of said plurality of primary holes has a rectangular shape, said plurality of primary holes being spaced apart from each other and being evenly distributed between said top end and said bottom end;
said primary lateral side has a pair of secondary holes each extending into said interior of said upper sleeve, each of said plurality of secondary holes having a bounding edge which has a plurality of intersecting sides such that each of said plurality of secondary holes has a rectangular shape; and
said secondary lateral side has a pair of tertiary holes each extending into said interior of said upper sleeve, each of said plurality of tertiary holes having a bounding edge which has a plurality of intersecting sides such that each of said plurality of tertiary holes has a rectangular shape, each of said tertiary holes being aligned with a respective one of said secondary holes such that each of said tertiary holes and said respective secondary hole defines a respective one of said secondary engagement points.

6. The assembly according to claim 5, wherein said forward side has a plurality of primary fastener holes each extending into said interior of said upper sleeve, each of said plurality of primary fastener holes being aligned with a respective one of said secondary holes or a respective one of said tertiary holes.

7. The assembly according to claim 6, wherein said primary lateral side has a plurality of secondary fastener holes extending into said interior of said upper sleeve, each of said plurality of secondary fastener holes being aligned with a respective one of said primary holes.

8. The assembly according to claim 7, wherein:
said lower sleeve has a plurality of first fastener holes and a plurality of second fastener holes;
each of said primary fastener holes is aligned with a respective one of said first fastener holes associated with said lower sleeve when said upper sleeve is inserted into said lower sleeve; and
each of said secondary fastener holes is aligned with a respective one of said second fastener holes associated with said lower sleeve when said upper sleeve is inserted into said lower sleeve.

9. The assembly according to claim 5, wherein said upper sleeve has a leg extending away from said upper end and a foot extending downwardly from said leg having said foot being spaced from the outside wall of said upper sleeve wherein said leg and said foot are configured to extend over and behind a top plate of the framed wall.

10. The assembly according to claim 8, wherein:
said lower sleeve has an outer wall having a front side, said front side having a plurality of first holes;
each of said plurality of first pegs has a first end and a second end, each of said plurality of first pegs having a foot extending away from said first end;
each of said plurality of first pegs has an aperture extending through a first lateral side and a second lateral side of said first pegs, said aperture in each of said plurality of first pegs being positioned adjacent to said second end; and
said second end of a respective one of said plurality of first pegs is insertable into a respective one of said first holes in said front side of said outer wall of said lower sleeve and said primary hole in said forward side of said outside wall of said upper sleeve that is aligned with said respective first hole having said aperture in said respective first peg being aligned with a respective pair of said first fastener holes and said second fastener holes associated with said lower sleeve and a respective pair of said primary fastener holes and said secondary fastener holes associated with said upper sleeve.

11. The assembly according to claim 1, wherein:
each of said second pegs has a primary end, a secondary end and a first surface extending between said primary end and said secondary end, each of said plurality of second pegs having a foot extending away from said primary end wherein said foot on each of said plurality of second pegs is configured to engage a lateral side of a respective one of a plurality of studs in the framed wall;
each of said plurality of second pegs has a recess in said first surface extending from said secondary end toward said primary end; and
each of said plurality of second pegs has an aperture extending through said first surface and a second surface of said second pegs, said aperture associated with each of said plurality of second pegs being positioned in said recess.

12. The assembly according to claim 11, wherein:
said lower sleeve has an outer wall having a first lateral side and a front side, said front side having a plurality of first holes, said first lateral side having a plurality of second holes, said front side having a plurality of first fastener holes;
said upper sleeve has an outside wall having a forward side and a primary lateral side, said forward side having a plurality of primary holes, said primary lateral side having a plurality of secondary holes; and
said secondary end of a respective one of said second pegs is insertable into a respective one of said second holes in said first lateral side of said outer wall of said lower sleeve and a respective one of said secondary holes in said primary lateral side of said outside wall of said upper sleeve having said aperture associated with said respective second peg being aligned with a respective one of said first fastener holes in said front side of said outer wall of said lower sleeve.

13. The assembly according to claim 1, wherein:
each of said third pegs has a primary end, a secondary end and a first surface extending between said primary end and said secondary end of said third pegs, each of said plurality of third pegs having a foot extending away from said primary end of said third pegs wherein said foot on each of said plurality of third pegs is configured to engage a lateral side of a respective one of a plurality of studs in the framed wall;
each of said plurality of third pegs has a recess in said first surface of said third pegs extending from said secondary end toward said primary end of said third pegs; and
each of said plurality of third pegs has an aperture extending through said first surface of said third pegs and a second surface of said third pegs, said aperture associated with each of said plurality of third pegs being positioned in said recess associated with said third pegs.

14. The assembly according to claim 13, wherein:
said lower sleeve has an outer wall which has a front side and a first lateral side and a second lateral side, said front side having plurality of first holes, said first lateral side having a plurality of second holes, said second lateral side having a plurality of third holes, said front side having a plurality of first fastener holes;
said upper sleeve has an outside wall which has a forward side and a primary lateral side and a secondary lateral side, said forward side having a plurality of primary holes, said primary lateral side having a plurality of secondary holes, said secondary lateral side having a plurality of tertiary holes;
each of said plurality of second pegs has a primary end and a secondary end; and
said secondary end of a respective one of said third pegs is insertable into a respective one of said third holes in said second lateral side of said outer wall of said lower sleeve and a respective one of said tertiary holes in said secondary lateral side of said outside wall of said upper sleeve having said aperture associated with said respective third peg being aligned with a respective one of said first fastener holes in said front side of said outer wall of said lower sleeve, said secondary end of said respective third peg overlapping said secondary end of said respective second peg when said respective third peg and said respective second peg are each inserted into said respective second engagement points.

15. A modular ladder assembly for facilitating a worker to climb along a framed wall, said assembly comprising:
a lower sleeve having a plurality of first engagement points being distributed along a full length of said lower sleeve, said lower sleeve having a plurality of second engagement points being distributed along a full length of said lower sleeve, said lower sleeve having a top end, a bottom end and an outer wall extending between said top end and said bottom end, lower sleeve being substantially hollow, said top end having an opening extending into an interior of said lower sleeve, said outer wall having a front side, a first lateral side and a second lateral side, said front side having a plurality of first holes each extending into said interior of said lower sleeve such that said plurality of first holes defines said plurality of first engagement points, each of said plurality of first holes having a bounding edge which has a plurality of intersecting sides such that each of said plurality of first holes has a rectangular shape, said plurality of first holes being spaced apart from each other and being evenly distributed between said top end and said bottom end, said first lateral side having a pair of second holes each extending into said interior of said lower sleeve, each of said plurality of second holes having bounding edge which has a plurality of intersecting sides such that each of said plurality of second holes has a rectangular shape, said second lateral side having a pair of third holes each extending into said interior of said lower sleeve, each of said plurality of third holes having bounding edge which has a plurality of intersecting sides such that each of said plurality of third holes has a rectangular shape, each of said third holes being aligned with a respective one of said second holes such that each of said third holes and said respective second hole defines a respective one of said second engagement points, said front side having a plurality of first fastener holes each extending into said interior of said lower sleeve, each of said plurality of first fastener holes being aligned with a respective one of said second holes or a respective one of said third holes, said first lateral side having a plurality of second fastener holes extending into said interior of said lower sleeve, each of said plurality of second fastener holes being aligned with a respective one of said first holes;
an upper sleeve being slidably insertable into said lower sleeve such that said upper sleeve and said lower sleeve has an adjustable combined length wherein said upper sleeve and said lower sleeve is configured to extend along a full height of a framed wall, said upper sleeve having a gripping element wherein said gripping element is configured to engage a top of the framed wall thereby attaching said upper sleeve and said lower sleeve to the framed wall, said upper sleeve having a plurality of primary engagement points being distributed along a full length of said lower sleeve, respective ones of said primary engagement points being alingable with a respective one of said first engagement points in said lower sleeve when said combined length of said upper sleeve and said lower sleeve is adjusted, said upper sleeve having a plurality of secondary engagement points being distributed along a full length of said upper sleeve, said upper sleeve having a upper end, a lower end and an outside wall extending between said upper end and said lower end, said upper sleeve being substantially hollow, said outside wall having a forward side, a primary lateral side and a secondary lateral side, said forward side having a plurality of primary holes each extending into said interior of said upper sleeve such that said plurality of primary holes defines said plurality of primary engagement points, each of said plurality of primary holes having a bounding edge which has a plurality of intersecting sides such that each of said plurality of primary holes has a rectangular shape, said plurality of primary holes being spaced apart from each other and being evenly distributed between said top end and said bottom end, said primary lateral side having a pair of secondary holes each extending into said interior of said lower sleeve, each of said plurality of secondary holes having a bounding edge which has a plurality of intersecting sides such that each of said plurality of secondary holes has a rectangular shape, said secondary lateral side having a pair of tertiary holes each extending into said interior of said lower sleeve, each of said plurality of tertiary holes having a bounding edge which has a plurality of intersecting sides such that each of said plurality of tertiary holes has a rectangular shape, each of said tertiary holes being aligned with a respective one of said secondary holes such that each of said tertiary holes and said respective secondary hole defines a respective one of said secondary engagement points, said forward side having a plurality of primary fastener holes each extending into said interior of said lower sleeve, each of said plurality of primary fastener holes being aligned with a respective one of said secondary holes or a respective one of said tertiary holes, said primary lateral side having a plurality of secondary fastener holes extending into said interior of said lower sleeve, each of said plurality of secondary fastener holes being aligned with a respective one of said primary holes, each of said primary fastener holes being aligned with a respective one of said first fastener holes associated with said lower sleeve when said upper sleeve is inserted into said lower sleeve, each of said secondary fastener holes being aligned with a respective one of said second fastener holes associated with said lower sleeve when said upper sleeve is inserted into said lower sleeve, said upper sleeve having a leg extending away from said upper end and a foot extending downwardly from said leg having said foot being spaced from the outside wall of said upper sleeve wherein said leg and said foot are configured to extend over and behind a top plate of the framed wall;
a plurality of first pegs, each of said first pegs being attachable to a respective one of said first engagement points in said lower sleeve or a respective one of said primary engagement points in said upper sleeve wherein each of said plurality of first pegs is configured to facilitate a user to climb on said plurality of first pegs thereby scaling the framed wall, each of said plurality of first pegs having a first end and a second end, each of said plurality of first pegs having a foot extending away from said first end, each of said plurality of first pegs having an aperture extending through a first lateral side and a second lateral side of said first pegs, said aperture in each of said plurality of first pegs being positioned adjacent to said second end, said second end of a respective one of said plurality of first pegs being insertable into a respective one of said first holes in said front side of said outer wall of said lower sleeve and said primary hole in said forward side of said outside wall of said upper sleeve that is aligned with said respective first hole having said aperture in said respective first peg being aligned with a respective pair of said first fastener holes and said second fastener holes associated with said lower sleeve and a respective pair of said primary fastener holes and said secondary fastener holes associated with said upper sleeve;
a plurality of second pegs, each of said second pegs being insertable into a respective one of said second engagement points in said lower sleeve and a respective one of said secondary engagement points in said upper sleeve wherein each of said plurality of second pegs is configured to engage the framed wall, each of said second pegs having a primary end, a secondary end and a first surface extending between said primary end and said secondary end, each of said plurality of second pegs having a foot extending away from said primary end wherein said foot on each of said plurality of second pegs is configured to engage a lateral side of a respective one of a plurality of studs in the framed wall, each of said plurality of second pegs having a recess in said first surface extending from said secondary end toward said primary end, each of said plurality of second pegs having an aperture extending through said first surface and a second surface of said second pegs, said aperture associated with each of said plurality of second pegs being positioned in said recess, said secondary end of a respective one of said second pegs being insertable into a respective one of said second holes in said first lateral side of said outer wall of said lower sleeve and a respective one of said secondary holes in said primary lateral side of said outside wall of said upper sleeve having said aperture associated with said respective second peg being aligned with a respective one of said first fastener holes in said front side of said outer wall of said lower sleeve;
a plurality of third pegs, each of said third pegs being insertable into a respective one of said second engagement points in said lower sleeve and a respective one of said secondary engagement points in said upper sleeve wherein each of said plurality of third pegs is configured to engage the framed wall, each of said third pegs having a primary end, a secondary end and a first surface extending between said primary end and said secondary end of said third pegs, each of said plurality of third pegs having a foot extending away from said primary end of said third pegs wherein said foot on each of said plurality of third pegs is configured to engage a lateral side of a respective one of a plurality of studs in the framed wall, each of said plurality of third pegs having a recess in said first surface of said third pegs extending from said secondary end toward said primary end of said third pegs, each of said plurality of third pegs having an aperture extending through said first surface of said third pegs and a second surface of said third pegs, said aperture associated with each of said plurality of third pegs being positioned in said recess associated with said third pegs, said secondary end of a respective one of said third pegs being insertable into a respective one of said third holes in said second lateral side of said outer wall of said lower sleeve and a respective one of said tertiary holes in said secondary lateral side of said outside wall of said upper sleeve having said aperture associated with said respective third peg being aligned with a respective one of said first fastener holes in said front side of said outer wall of said lower sleeve, said secondary end of said respective third peg overlapping said secondary end of said respective second peg when said respective third peg and said respective second peg are each inserted into said respective second engagement points;
a plurality of first fasteners, each of said plurality of first fasteners being insertable through a respective one of first fastener holes in said front side of said outer wall of said lower sleeve or a respective one of said primary fastener holes in said forward lateral side of said outside wall of said upper sleeve and extend through said aperture in a respective one of said second pegs to secure said respective second peg in said lower sleeve or said upper sleeve;
a plurality of second fasteners, each of said plurality of second fasteners being insertable through a respective one of said first fastener holes in said front side of said outer wall of said lower sleeve or a respective one of said primary fastener holes in said forward side of said outside wall of said upper sleeve and extend through said aperture in a respective one of said third pegs for securing said respective third peg in said lower sleeve or said upper sleeve; and
a plurality of third fasteners, each of said plurality of third fasteners being insertable through a respective one of said second fastener holes in said first lateral side of said outer wall of said lower sleeve or a respective one of said secondary fastener holes in said primary lateral side of said outside wall of said upper sleeve and extend through said aperture in a respective one of said first pegs for securing said respective first peg in said lower sleeve or said upper sleeve.
